(19) United States
(12) Patent Application Publication
(10) Pub. No.: US 2024/0242625 A1
(43) Pub. Date: Jul. 18, 2024

(54) Systems, Methods and Devices for Practical Language Training

(71) Applicant: VERBAL BRIDGES LLC, Houston, TX (US)

(72) Inventor: Maribel Reyna, Houston, TX (US)

(21) Appl. No.: 18/414,379

(22) Filed: Jan. 16, 2024

Related U.S. Application Data
(60) Provisional application No. 63/439,255, filed on Jan. 16, 2023.

(51) Int. Cl. G09B 19/06; H04N 7/15

(52) U.S. Cl. CPC G09B 19/06; H04N 7/15

(57) ABSTRACT

New systems, methods and devices for facilitating collaborative, immersive distance learning of human languages and, in particular, for the practical learning of human languages through conversational speaking via remote videoconferencing techniques, are provided. A learning system including specialized computer hardware (including peripheral devices and/or sensors) and software creates a series of unique A/V conversation GUI tools for a unique cohort of users including learning users and teaching users. Such cohorts are based, at least in part, on: a speaking skills estimate in a goal learning language, a goal teaching language, and another language, a Learning Path, an assessment of speaking skills, and a Confidence Score. A series of chat rooms are created, and the performance of users in one or more A/V conversation session(s) is determined. One or more users of the cohort are provided with access to additional resources if a pre-set threshold is reached.

### CROSS-REFERENCE TO RELATED APPLICATION

This application claims the benefit of U.S. Provisional Application No. 63/439,255 filed Jan. 16, 2023, the entire contents of which are hereby incorporated by reference herein into the present application.

### INTELLECTUAL PROPERTY NOTICE

A portion of the disclosure of this patent document contains material which is subject to copyright protection. The copyright owners have no objection to the facsimile reproduction by anyone of the patent document or the patent disclosure, as it appears in the Patent and Trademark Office patent file or records, but otherwise reserves all copyright rights whatsoever. Unless otherwise stated, all trademarks and trade dress disclosed in this patent document and other distinctive names, emblems, and designs associated with product or service descriptions, are subject to trademark rights. The trademark and trade dress owner also reserves all trademark rights whatsoever.

### FIELD OF THE INVENTION

The present invention relates to systems and devices for facilitating practical learning of human languages and, in particular, to systems and devices for learning languages via remote videoconferencing.

### BACKGROUND

Teleconferencing began with the inception of telephony in the late 19th century, when Alexander Graham Bell commercialized his patent on the telephone. After transcontinental phone infrastructure was laid, including multiplex switchboards, it became possible to connect more than two participants in an audio teleconference. In an early notable teleconference, Bell himself was connected with the mayors of San Francisco and New York and President Wilson, to commemorate the Panama-Pacific International Exposition of 1915. The call was extremely difficult and expensive to connect, and audio teleconferencing would not become accessible to the public for many years to come.

In the 1950's, Bell Labs and AT&T began creating teleconferencing systems for commercial use in earnest, including early video teleconferencing technologies. AT&T's PICTUREPHONE was displayed at the World's Fair in New York, in 1956. The PICTUREPHONE met with a lukewarm reception. The PICTUREPHONE system was extremely expensive and complicated to operate, and the video image quality was poor. AT&T eventually launched general commercial service for the PICTUREPHONE in 1970, but it was rarely used. Teleconferencing, and video teleconferencing in particular, remained expensive and unpopular for decades. But major electronics companies continued to develop new systems. For example, AT&T launched the VIDEOPHONE in 1992, but this teleconferencing system again had a high price tag, and still met with a tepid reception, forcing AT&T to offer large discounts.

In 1999, KYOCERA introduced what might have been the first general commercial offering of a camera-enabled wireless telephone—the VISUALPHONE VP-210. Operating at a rate of 2 frames per second (“FPS”), its front-facing camera allowed users to hold video teleconference calls from remote locations.

In modern times, teleconferencing may be carried out over several possible forms of communications networks, including wireless networks and the Internet. Teleconferencing systems by GOOGLE MEET, ZOOM, MICROSOFT TEAMS and WEBEX are among the most popular software-based options available over the Internet, and can run at about 30 FPS. This frame rate is some 15× the output of VISUALPHONE in 1999, and around the rate of modern cinematic frame rates. But issues like lag and freezing have remained as persistent problems, frequently raised by users. Some teleconferencing software applications include texting (a.k.a. “chat”) features, and virtual whiteboards, allowing multiple team members on a project to collaborate on written work in real time, as well as oral conversations. Recently, the popularity of these modern platforms has increased, albeit, perhaps, temporarily, in the wake of the ongoing Covid-19 global pandemic beginning in 2019, which has placed a premium on collaboration between people at a safe distance.

Despite increasing, long-felt needs for better teleconferencing systems, all modern offerings remain widely criticized in comparison to in-person conferencing, for several of reasons. For example, “telepresence” through such systems may feel less genuine and familiar than actual, in-person meetings, and there are frequent technical issues inherent in teleconferencing technologies, as mentioned above.

Some new teleconferencing systems include robot-mounted cameras and video projection displays in place of a “head” of a robot, and allow the robot to serve as a telepresence avatar of a remote conference participant—moving as if it were that participant's body, through another teleconference participant's physical environment. However, these systems have not bridged the uncanny valley of teleconferencing—users remain uncomfortable with such teleconferencing systems, and there remains a strong, long-felt need for better teleconferencing systems, devices and methods.

In recent years, personal computers have become far more powerful. Extremely powerful, portable personal computers, including small digital assistants (“PDAs”) have allowed users to record and manage personal information, and conduct complex communications in a wide variety of forms for decades. For example, as early as the 1970's, small digital wristwatches allowed users to perform personal computing, such as financial arithmetic, and storing information related to personal contacts, such as names, addresses and phone numbers. Like desktop computers, even common smartphones have had enormous computing capabilities for some time.

A wide variety of specialized software products (“Apps”) have been designed to be run on personal computers, known as “Desktop Apps,” on smartphones, in which case they are known as “Smartphone Apps,” and/or on remote servers, via virtual computers, over the Internet, in which case they are known as “Web Apps”. Apps allow users to provide and receive a wide variety of data, and perform a wide variety of functions based on those data, ranging from online banking to digital gaming.

Some Apps relate to learning languages, such as human languages. For example, many Web Apps are currently available to aid users in learning vocabulary, grammar rules, cultural customs and pronunciation. As another example, some Web Apps allow users to converse via teleconferencing techniques, either through those Web Apps, or with the aid of additional Web Apps (e.g., ZOOM, as discussed above, or DISCORD, as used by DEUTSCH GYM). At least one Web App, namely LEARNCUBE.COM, counts the amount of time that a user has spent speaking in the Web App.

Despite the wide availability and popularity of language learning Apps, and the availability of Apps including virtual classrooms and teleconferencing capabilities, results have been surprisingly poor. For example, one study of open online language learning courses noted a completion rate of between 2.4 to 18.2%. See K. Friodriksdottir & B. Arnbjornsdottir, Tracking Student Retention in Open Online Language Courses (2015). And retention rates for language learning Apps appear to be far lower than indicated in that study. Language learning remains extremely challenging through Apps, and there remains a long-felt need for more effective language learning Apps, devices, systems and other techniques.

It should be understood that the disclosures in this application related to the background of the invention, in, but not limited to this section titled “Background,” do not necessarily set forth prior art or other known aspects exclusively, and should not be construed as an admission with respect thereto.

### SUMMARY OF THE INVENTION

New systems, methods and devices for facilitating collaborative, immersive distance learning of human languages and, in particular, for the practical learning of human languages through conversational speaking via remote videoconferencing techniques, are provided. In some embodiments, a learning system including specialized computer hardware (including peripheral devices and/or sensors) and software creates a series of unique audio-visual (“A/V”) conversation GUI tools for uniquely created cohorts of users, including both learning users and teaching users. In some embodiments, the learning system creates such cohorts based, at least in part, on one or more of: a speaking skills estimate for users in a goal learning language; a goal teaching language; and another language indicated by users; a Learning Path selection; a real-time assessment of speaking skills; and a Confidence Score. In some embodiments, the learning system creates a series of A/V conversation chat room tools for the cohort of users, and monitors the performance of users in one or more A/V conversation session(s). In some embodiments, the learning system provides to one or more users of such a cohort of users with access to additional resources, such as additional A/V chat sessions, if a pre-set threshold for Speaking Time is reached and/or exceeded.

In some embodiments, a human language learning system (the “learning system”), includes software modules and GUI tools, aiding in qualifying and grouping cohorts of learning users and teaching users of a human language to be learned by the learning users. In some such embodiments, using the learning system, one or more learning user(s) select at least two languages: a first human language, which is a language in which the user has speaking fluency, and a second, goal learning human language (the “goal learning language”), which the user desires to learn and/or practice speaking. Also using the learning system, one or more teaching user(s) select at least two languages: a “goal teaching language,” which is a human language with which such a teaching user has a high level of fluency; and other human language(s), which the teaching user will not be teaching, but in which the teaching user has some ability to converse for purposes of teaching students who are fluent in that language. In some embodiments, a level of language speaking ability is then determined for each user, in each user's goal learning language or goal teaching language, as the case may be. In addition, one or more Learning Path(s) are then selected and/or determined by each of the learning user(s) and the teaching user(s), which Learning Path(s) reflect subject matter interests. In some embodiments, particular learning user(s) are then grouped together in cohorts of users, based on a user-matching software module of the learning system, based on such language speaking abilities and Learning Path(s). In some embodiments, the learning system creates manages chat room(s) for hosting Audio/Video (A/V) Conversations, starting with a large, Group Immersion A/V chat room (e.g., hosting around 30 users), which large, Group Immersion A/V chat room hosts an initial, group immersion A/V Conversation session between those users of that cohort.

One or more language speaking ability assessment modules are provided within the Learning System, in some embodiments, which are then applied to monitored and/or recorded speaking performance of any such learning user and any such teaching user, respectively. In some embodiments, such an assessment module may, at least in part, include an artificial intelligence (e.g., machine learning) sub-module, which compares a variety of factors of each such user, based on such factors and/or performances of prior learning and teaching users, and their abilities as rated previously, over time (e.g., by administrators coaching the machine learning sub-module with examples of such high- and low-ability prior users). In some embodiments, such an assessment module may, at least in part, include a speaking time recording sub-module, in which each user's amount of time speaking, proportion of time speaking relative to other speakers, and verbal fluidity and talking speed, may be determined. For example, in some embodiments, such a sub-module first transcribes each user's speech during the A/V session into an OCRed transcript, which is then analyzed for grammatical and/or pronunciation errors, speech rate, and such speaking time, and proportion of speaking time, in some embodiments.

In some embodiments, users may then be compared and associated with each other to different degrees, e.g., by a user matching module of the control system. In some embodiments, such an algorithm creates a comparative coefficient of speaking ability in a human language (e.g., by regression analysis of a group of weighted comparisons of a group of statistical indicators, such as any of the statistical indicators of speaking performance set forth in this application) applied to each learning user and teaching user.

Based on the techniques above, in some embodiments, those users of that cohort sharing a particular Learning Path and general language speaking ability, are presently determined, and the learning system assigns sub-sets of the cohort of users to smaller, Breakout Cohorts (e.g., 3 to 4 users each), based on the results of applying a matching sub-module of the learning system. In some embodiment, each set of users assigned to a Breakout Cohort are then placed into additional, smaller A/V chat rooms (“Breakout Rooms”) and subjected to an additional A/V conversation session (a “Breakout Session”), together, and speaking ability assessment module(s) of the Learning System. In some embodiments, the learning users are provided with tasks to complete during the Breakout Session, and their performance in speaking during the Breakout Session is determined. In some embodiments, at a conclusion of the Breakout Session, each learning user is returned to the Group Immersion A/V chat room, from the Breakout Room(s) and provided with a GUI tool for reporting a Confidence Score, meaning a numerical or other self-rating (e.g., on a scale of 1-10) of their confidence that they have spoken well, and/or improved their spoken language skills, in their goal learning language. Also upon so returning each user to the first, Group Immersion A/V chat room, in some embodiments, the control system may report any or all of the ratings, scores, speaking times, relative speaking times, for each user in a Score Reporting GUIs.

In some embodiments, each user must meet or exceed one or more thresholds for particular score(s) relating to their speech (e.g., a minimum speaking time, or proportion of speaking time, as discussed above), or they are then returned to steps 411 et seq., as set forth above, and repeat all such steps until they have so met or exceeded such threshold(s).

In some such embodiments, teaching users may be matched with learning users in such a tranche or cohort based only if their assessed and determined language skill level (e.g., by their coefficient of speaking ability) is higher than all learning users in that tranche or cohort.

In some embodiments, the Learning System only groups users within a cohort or breakout cohort when particular criteria are met. For example, in some embodiments, the Learning System so matches teaching users to a cohort only if: teaching user is tested and verified to be fluent (e.g., a native speaker) in the goal learning language of each learning user of the cohort.

In some embodiments, additional forms of A/V chat rooms and learning tools are also provided by the Learning System, including: Learning Path Rooms, in which a particular learning objective(s) is facilitated by the Systems, through guided A/V interactions; and Seasonal/Event Rooms, in which a Session is held on a particular date, occasion or other social initiative of the users.

In some embodiments, Learning Users are presented with initial, introductory A/V experiences and instructions, at or about their initial connection to it (e.g., a pre-recorded Welcome video).

In some embodiments, the Learning System facilitates oral conversations between users, in real time, over audio/video chat sessions. For example, the Systems may carry out any or all of the following learning facilitation steps: presenting language learning and interaction instructions, at the outset, when users are connected to Rooms and/or when a Session begins; setting out particular language learning tasks, to be carried out by each user, during the Session; identifying improper word choice, grammar and intonation can be detected by the systems and/or users (e.g., the second, teaching user); identifying/requiring a particular user to begin speaking and carrying out other language learning instructions; tracking and calculating the Speaking Time of each user (e.g., with a “Speaking Tracker” aspect of the systems.

As mentioned above, in some embodiments, the Speaking Time for each user must reach a set threshold (e.g., a preselected threshold, by the system and/or user with administrative privileges) or the user is placed in another Room, for another similar A/V chat session. In some embodiments, the Systems grant special access privileges to a user if the user reaches and/or exceeds the preselected threshold applicable to them. In other words, by reaching their threshold, the user is considered qualified for, and granted additional access to Special aspects of the System, in such embodiments.

In some embodiments, the Speaking Time is displayed as a score for each user, after a Session ends. In some such embodiments, the Speaking Time for each user, and whether they reached their applicable threshold, is displayed to all users, after a Session ends.

In some embodiments, users are provided with a User Interface Tool to rate their courage in their speaking performance or abilities, at the end of the session. In some embodiments, the users provide a self-rated “Confidence Score” (e.g. from 0 to 100, 100 being the most confident, and 0 being no confidence) in their performance during an A/V chat session. In some embodiments, as with the Speaking Time parameter, above, the Systems grant special access privileges to a user if the user's Confidence Score reaches and/or exceeds the preselected threshold applicable to them (e.g., 70% Confidence in their last performance at an A/V chat session). In other words, by reaching their threshold, the user is considered qualified for, and granted additional access to Special aspects of the System, in such embodiments.

Within a GUI Tool for each user, cumulative Speaking Time, across all Sessions in which the user participates, is summed and displayed, among other things.

In some embodiments, a Leader Board is provided, showing the top-ranked speakers within a cohort or the community.

Points will be awarded for the second, teaching user, for aiding learners by speaking and otherwise helping in Sessions. In some embodiments, the points can be redeemed through the Systems for monetary or other awards.

In some embodiments, in addition to the A/V Conversations/Sessions, the Systems have several other features, facilitated by independent software modules which can be separately selected and used by users in a single integrated Learning Path (i.e., a unique learning experience for that user facilitated by the Systems), depending on their language learning goals. These modules include, by way of example:
Language-Specific Modules: Learning System aspects related to the particular first and second languages subject to a Session (see above);
Ability Level Modules: (discussed above); and
Learning Path Modules: Learning System aspects that present specialized GUI tools for completing lessons and other techniques, in addition to A/V conversations, relevant to a user's selected Learning Path.

### Canons of Construction

Where any term is set forth in a sentence, clause or statement (“statement”) in this application, each possible meaning, significance and/or sense of any term used in this application should be read as if separately, conjunctively and/or alternatively set forth in additional statement(s), after the sentence, clause or statement, as necessary to exhaust the possible meanings of each such term and each such statement.

It should also be understood that, for convenience and readability, this application may set forth particular pronouns and other linguistic qualifiers of various specific gender and number, but, where this occurs, all other logically possible gender and number alternatives should also be read in as both conjunctive and alternative statements, as if equally, separately set forth therein.

The embodiments set forth in detail in this application are to ease the reader's understanding of inventions set forth herein and, as such, are only examples of the virtually innumerable number of alternative embodiments falling within the scope of the application. No specific embodiment set forth in this application should be read as limiting the scope of any claimed inventions.

These and other aspects of the invention will be made clearer below, in other parts of this application. This Summary, the Abstract, and other parts of the application, are for ease of understanding only, and no part of this application should be read to limit the scope of the invention, whether or not it references matter also set forth in any other part.

### BRIEF DESCRIPTION OF THE DRAWINGS

The features and advantages of the example embodiments of the invention presented herein will become more apparent from the detailed description set forth below when taken in conjunction with the following drawings.

FIG. 1 depicts an example graphical user interface (“GUI”), including some example GUI tools configured for facilitating the practical learning of human languages by a user, in part, by a remote teleconferencing system (a “language learning system”), in accordance with some embodiments.

FIG. 2 depicts another example GUI, including some additional example GUI tools, which may be utilized by a user of such a language learning system, in accordance with some embodiments.

FIG. 3 depicts another example GUI, including some additional example GUI tools, which also may be utilized by a user of such learning system, in accordance with some embodiments.

FIG. 4 is a process flow diagram, illustrating several example steps that may be carried out by a control system, such as the example control system set forth below, in reference to FIG. 13, of such a language learning system, in accordance with some additional embodiments.

FIG. 5 is a process flow diagram, illustrating several additional example steps that may be carried out by a control system, such as the example control system set forth below, in reference to FIG. 13, of a language learning system, in accordance with some additional embodiments.

FIG. 6 depicts another example GUI, including some additional example GUI tools, which also may be utilized by a user of such learning system, in accordance with some embodiments.

FIG. 7 depicts another example GUI, including some additional example GUI tools, which also may be utilized by a user of such learning system, in accordance with some embodiments.

FIG. 8 depicts another example GUI, including some additional example GUI tools, which also may be utilized by a user of such learning system, in accordance with some embodiments.

FIG. 9 depicts another example GUI, including some additional example GUI tools, which also may be utilized by a user of such learning system, in accordance with some embodiments.

FIG. 10 depicts another example GUI, including some additional example GUI tools, which also may be utilized by a user of such learning system, in accordance with some embodiments.

FIG. 11 depicts another example GUI, including some additional example GUI tools, which also may be utilized by a user of such learning system, in accordance with some embodiments.

FIG. 12 depicts another example GUI, including some additional example GUI tools, which also may be utilized by a user of such learning system, in accordance with some embodiments.

FIG. 13 is a schematic block diagram of some elements of a control system in accordance with some example embodiments of the invention.

### DETAILED DESCRIPTION OF THE INVENTION

The features and advantages of the example embodiments of the invention presented herein are directed to new systems, methods and devices for facilitating the practical learning of human languages and, in particular, to systems and devices for learning languages via remote videoconferencing. These and other aspects will become more apparent from the detailed description set forth below when taken in conjunction with the following drawings. This description is not intended to limit the application to the embodiments presented herein, which are only examples of the virtually unlimited possible embodiments falling within the scope of the present application. In fact, after reading the following description, it will be apparent to one skilled in the relevant art(s) how to implement the following example embodiments in alternative embodiments, including any possible order, number or other arrangement of components and sub-components (the following order, components, subcomponents and/or relationships being non-limiting).

### DETAILED DESCRIPTION OF THE INVENTION

The example embodiments of the invention presented herein are directed to new systems, devices and methods for facilitating the practical learning of human languages and, in particular, to systems and devices for learning languages via remote videoconferencing, which are now described herein. This description is not intended to limit the application of the example embodiments presented herein. In fact, after reading the following description, it will be apparent to one skilled in the relevant art(s) how to implement the following example embodiments in alternative embodiments.

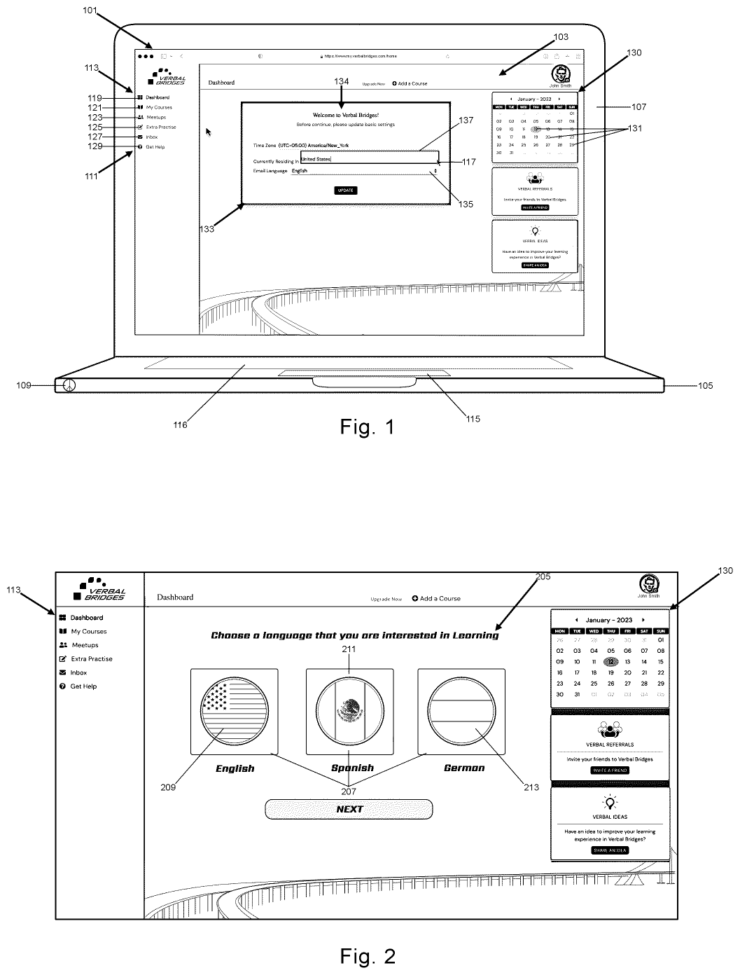

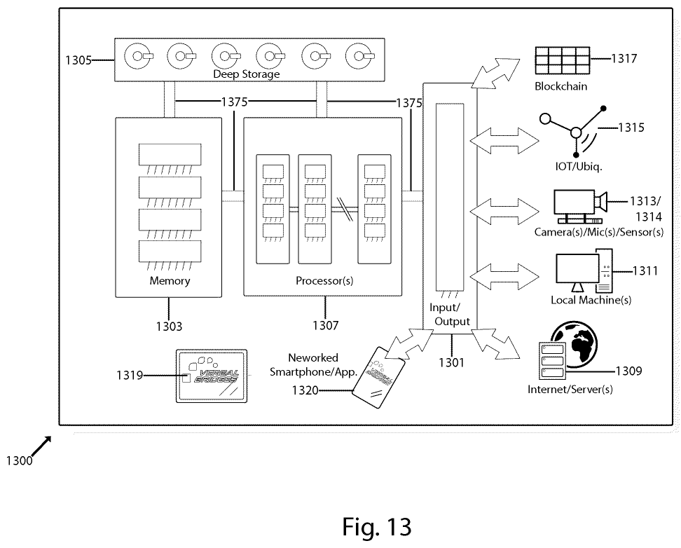

FIG. 1 depicts an example graphical user interface (“G.U.I.” or “GUI”) 101, including some example GUI tools 103, configured for use by a user of a system for facilitating the practical learning of human languages, in part, by remote teleconferencing (the “learning system,” which may be any of the example systems set forth in the present application), in accordance with some embodiments. As with any other GUI elements set forth in the present application, in some embodiments, GUI 101 may be may be presented and controlled by computer hardware and software of a control system, such as the example control system provided below, in reference to FIG. 13, which may comprise, and/or be comprised within, the learning system, in some embodiments. In some embodiments, such a control system may include, or be included within, a computer 105, including local computer hardware, such as local display 107, and specialized software (e.g., a desktop software application, or “App”) which, when executed, causes some of the methods, steps and processes set forth in this application to take place. But, if so, preferably, in some embodiments, computer 105 is connected for communications (e.g., to the internet, via wireless communications antenna 109) and thus networked with another control system including computer hardware and software (e.g., a remote server), with additional specialized software (e.g., an SaaS web application) which, when executed, causes some of the steps and processes set forth in this application to take place. In some embodiments, a smartphone or other peripheral device-based app is included, as a part of, or in communication with, the control system. The example of a local computer 105, and the specific example format of a laptop computer as pictured, is only one example of the virtually unlimited alternative forms and numbers of local and network-accessible computers that may be used to carry out aspects of the inventions set forth in this application, as will be apparent to those of skill in the art. For example, in some embodiments, multiple such local computers are provided. As another example, in some embodiments, no local computer connected to a network is provided, and, instead, all GUI tools and processes may be carried out on a single computer, which is not part of a network, in some embodiments. As another example, in some embodiments, the format of a computerized peripheral device, such as a smartphone or other personal digital assistant device is substituted for the format pictured (computer 105). In any event, as will be readily apparent to those of skill in the art to which this application pertains, any such computer, and any number and combination of such computers and networks connecting them, may relay instructions and other information and monitor user selections, data input, and other user behavior, through the GUI tools provided in the present application, such as the example GUI tools set forth below, to aid in carrying out any and all of the methods, steps and processes set forth in this application, in various alternative embodiments. Of course, it would be impossible to list the unlimited possible numbers and combinations of such alternative embodiments, as also would be readily apparent to those of skill in the art, and the specific example provided, of a networked personal computer 105 is merely one of those unlimited alternative embodiments for hardware implementations falling within the scope of the invention(s) set forth in this application.

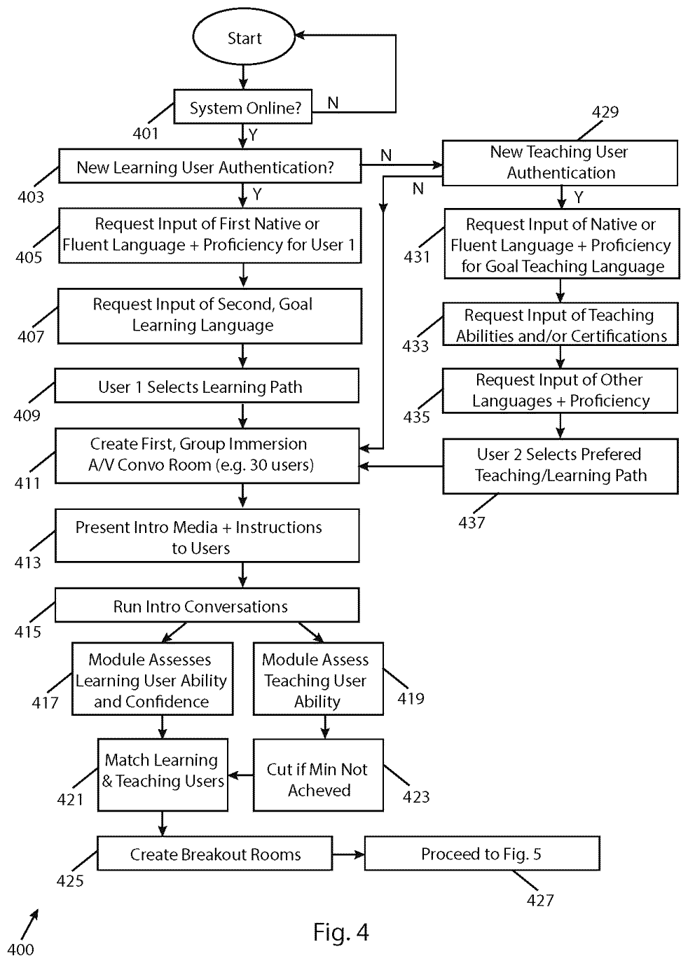

In some embodiments, and assuming that a user of the learning system (not pictured but, e.g., a person using computer 105) has already created and logged in to its account, as set forth in step 403 et seq., discussed below in reference to FIG. 4, such GUI tools may be such as those shown as example GUI tools 103. Generally speaking, in the example pictured, GUI tools 103, and other GUI tools set forth in this application, aid a user in learning a human language and, in particular, a second human language (which may be a language that is non-native for the user, in some such embodiments), at least in part, with the aid of other user(s), and conversations using remote teleconferencing. It should be noted that the specific GUI tools, methods, steps, processes and activities to be provided below, will vary greatly in different embodiments of the invention. As will be understood by those of ordinary skill in the art, the specific examples provided are merely illustrative, and other software modules, methods, steps, processes and GU. tools adapted for them, may be substituted, in various alternative embodiments.

In any event, as discussed above, GUI 101 includes several example GUI tools 103, adapted for the user to begin using the learning system (after proper log-in and authentication). For example, one such GUI tool is pictured as a main navigation selection menu 111 including a series of navigable link tools 113 which, when activated by the user allow the user to navigate to different sets of GUI tools (“pages”) presented by the learning system, including sets of GUI tools other than those pictured in the present figure as GUI tools 103 (e.g., presented on other “pages” created by html and other programming). For example, in some embodiments, the user may select and activate any of navigable links tools 113, e.g., by using mouse 115 and/or keyboard 116 to place a pointer tool, such as arrow-format pointer tool 117, presented on display 107 over any of the example navigable link tools 113 and “clicking on” them, using mouse 115, or otherwise selecting them with such a data input device. A discussion of some of the example navigable link tools 113, in some embodiments, directly follow. Homescreen navigation link tool 119, in some embodiments, when selected and activated by the user, causes the learning system to present a “home screen” or “dashboard” GUI, which may be a GUI similar to that pictured. In some embodiments, a branding page navigation tool 121 is also, or alternatively, provided, which, in some embodiments, when similarly selected and activated by the user, similarly causes the learning system to present a “home screen” or “dashboard” GUI, which may be a GUI similar to that pictured. A selected courses navigation link tool 123 is also provided, which, in some embodiments, when similarly selected and activated by the user, presents a GUI related to selecting, exploring and engaging in language learning courses, or learning paths, with the aid of the learning system. An extra practice navigation link tool 125 is provided, which, in some embodiments, when similarly selected and activated by the user, causes the learning system to present a GUI related to engaging in ad hoc and/or additional practical language training (other than that previously required and/or scheduled or part of a planned curriculum or learning path) to be engaged in by the user with the aid of the learning system. An e-mail and/or text messaging inbox navigation link tool 127 is provided, which, in some embodiments, when similarly selected and activated by the user, causes the learning system to present a GUI related to viewing and composing e-mail(s) and/or text message(s) to and from other users of the learning system (or, in some embodiments, administrators of the learning system). A system help navigation link tool 129 is provided, which, in some embodiments, when similarly selected and activated by the user, causes the learning system to present a GUI related to requesting and viewing helpful information, messages and other assistance (e.g., from administrators of the learning system, via support tickets).

Also among the example GUI tools 103 is a scheduling GUI tool 130. In some embodiments, scheduling GUI tool 130 aids a user in creating and scheduling Audio-Visual (“A/V”) conversation sessions and other language learning tools available through the learning system, on particular dates and at particular times. In some embodiments, scheduling GUI tool 130 may include navigable links, such as the example navigable links 131, which, when activated by the user, cause the learning system to present more detailed date-and-time scheduling GUI tools for each day of a calendar year(s), which may be used to create A/V conversation chat rooms, as well as scheduling conversation sessions at particular times, with particular participants (in some embodiments, other users). In some embodiments, scheduling GUI tool 130 may include GUI tools for inviting other users to participate in such conversations using such A/V conversation chat rooms.

In some embodiments, upon first accessing GUI 101, the user may be presented with a welcoming GUI tool 133. In some embodiments, welcoming GUI tool 133 introduces the user to GUI 101 and the learning system, with various welcome messages 134, and includes an initial language selection GUI sub-tool 135, for selecting an initial main human language (or, a human language in which the user wishes to receive messages from the learning system). In some embodiments, the learning system supports learning of, and such messaging in, a plurality of human languages. For example, in some such embodiments, the learning system supports learning of, and such messaging in leading popular human languages. For example, in some such embodiments, the learning system supports learning of, and such messaging in, at least, English, German, Spanish and French. Thus, in some embodiments, after activation by the user, as pictured, and selecting such a first human language of the user, other functions and GUIs of the language learning system may incorporate and reflect that language as a means for reliably communicating with the user, with the aim of completing further tasks and actions by that user, and communicating with that user. In some embodiments, welcoming GUI tool 133 also includes a location and time zone selection GUI sub-tool 137, which, when activated by the user, as pictured, allows the user to select their physical location and/or preferred local time zone. In some embodiments, all scheduling and time-based planning functions of the learning system, and related GUI tools presented by the learning system, account for and reflect the user's selected time zone and location. Upon such a selection, and or, upon completing and closing welcoming GUI tool 133, the learning system may proceed to other GUIs and GUI tools, some of which will be discussed below.

As will be apparent to those of ordinary skill in the art to which the present invention applies, a wide range of alternative GUIs and GUI tools may include, or be modified to include or combine with, the GUIs, aspects and techniques of the present invention, as set forth in this application, in some embodiments. The mention, depiction or discussion of any specific language, type or stylization of GUI tools and graphical features are only examples of the virtually unlimited alternatives falling within the scope of the invention.

Generally speaking, the exact detailed embodiments provided throughout this application, including the aspects and techniques set forth in the figures and discussed in detail in this application are, of course, examples, and not limiting. Rather, these embodiments are intended only as a reasonable set of possible example systems, graphics, structures, substructures, GUIs, methods, steps, techniques and other aspects of the present invention, among virtually infinite and innumerable possibilities for carrying out the present invention, to ease comprehension of the disclosure, as will be readily apparent to those of ordinary skill in the art. For example, the description of one particular order, number or other arrangement of any aspects of the present invention set forth herein is illustrative, not limiting, and all other possible orders, numbers, arrangements, etc., are also within the scope of the invention, as will be so readily apparent. Any aspect of the invention set forth in this application may be included with any other aspect, as well as any aspects known in the art, in any number, order, arrangement, or alternative configuration, in particular embodiments, while still carrying out, and falling within the scope of, the invention.

Generally, GUI tools 103, and any other GUI tools and sub-tools set forth in the present application may include a wide variety of alternate forms and media, and any known types of tools for making selections or activating processes and steps set forth in this application may be used in various embodiments, alternatively or in addition to the forms of GUI tools and sub-tools set forth herein. For example, in some embodiments, alternative visual forms of GUI tools, or auditory, haptic or other non-visual GUI tools may be provided.

FIG. 2 depicts an example GUI 201, including some additional example GUI tools 203, which also may be utilized by a user of such learning system, in accordance with some embodiments. As with other GUIs and GUI tools set forth in the present application, in some embodiments, GUI tools 203 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, a computer, such as example computer 105, has been omitted in the present figure.

In some embodiments, GUI 201 and GUI tools 203 include several of the same GUI tools set forth above, with reference to FIG. 1—for example, each of navigable link tools 113 and scheduling GUI tool 130 remain, as presented by the learning system. However, after the user completed and/or closed the welcoming GUI tool 133, as discussed above, additional example GUI tools have been created by the system. For example, a second, goal learning language selection tool 205 has now been presented by the learning system (i.e., the control system thereof). In some embodiments, goal learning language selection tool 205 includes selectable GUI sub-tools 207 for selecting a second language (other than the first, main human language selected by the user, as set forth above). Whereas, in some embodiments, the first, main human language selected by the user was the user's native language, or another language in which the user has fluency, in some embodiments, the second language is a different language, which the user desires to learn and/or practice, and may not have fluency in, in some embodiments. For example, in some embodiments, the user may desire and/or be required to learn and increase their fluency in the second language for any number of various reasons, including business, employment, academic, travel, personal, and/or other reasons. In some embodiments, a wide variety of possible second languages may be presented and supported as selectable options within second, goal learning language selection tool 205, via selectable GUI sub-tools 207. In some embodiments, selectable GUI sub-tools 207 include several selectable GUI tools that, when activated, cause the control system to select particular software modules and undertake steps to aid the user in learning and practicing (e.g., via A/V conversations) that selected second language, rather than another second language, as set forth in this application. For example, in some embodiments, the control system tests, certifies and matches other users, such as one or more teacher users or learning users, with the user, and allows such users to interact with the user, in accordance with techniques set forth in this application, based on the user's selection of such second language. In the example pictured, selectable GUI sub-tools 207 include: an English individually selectable sub-tool 209, in the form of an actuable GUI button which, when activated by the user, selects the English language as such a second language; a Spanish individually selectable sub-tool 211, in the form of an actuable GUI button which, when activated by the user, selects Spanish as such a second language; and a German individually selectable sub-tool 213, in the form of an actuable GUI button which, when activated by the user, selects German as such a second language. However, of course, this specific example of three specific second language options is merely illustrative, and not exhaustive of the innumerable combinations and numbers of second language options which may be so presented, in various embodiments. In alternative embodiments of GUI 201, and other GUIs set forth herein, any number and variety of any known human language(s), both fewer and greater than that specifically provided in the present figures, may be presented by the control system, and selected by the user. In some embodiments, only one such second language may be selected and, after selection, may prevent the selection of other such second languages (at least, until such time as the other second language is no longer selected, or deselected, in some embodiments).

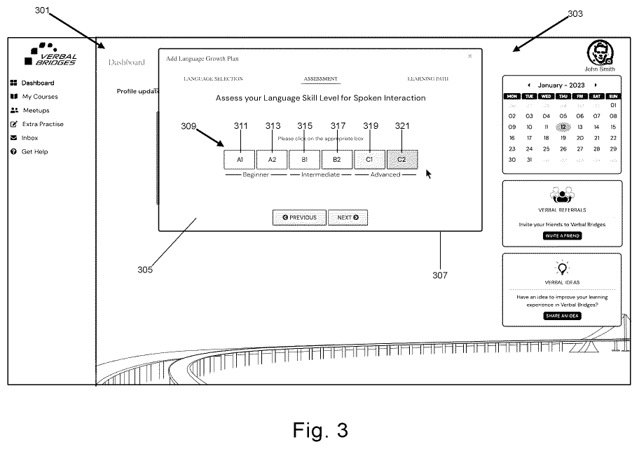

FIG. 3 depicts an example GUI 301, including some additional example GUI tools 303, which also may be utilized by a user of such learning system, in accordance with some embodiments. As with other GUIs and GUI tools set forth in the present application, in some embodiments, GUI tools 303 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with FIG. 2, above, a computer, such as example computer 105, has been omitted in the present figure.

In some embodiments, GUI 301 and GUI tools 303 include several of the same GUI tools set forth above, with reference to FIGS. 1 and 2. However, after the user completed their selection of a second language, using GUI tools 203, as discussed above, additional example GUI tools, have been created by the system. For example, an example second language ability self-assessment tool 305 is now provided, in the form of a pop-up window 307. In some embodiments, second language ability self-assessment tool 305 includes selectable GUI sub-tools 309 allowing a user to indicate their speaking skill level in the second language that they selected using GUI tools 203. In various embodiments, a wide variety of possible skill levels, based on any known or new system for evaluating and grading spoken language skills, may be presented and supported as selectable options within second language ability self-assessment tool 305. In some embodiments, selectable GUI sub-tools 309 include several selectable GUI tools that, when activated, cause the control system to select particular software modules and undertake steps to aid the user in learning and practicing (e.g., via A/V conversations) based on the skill level that they indicate using selectable GUI sub-tools 309. For example, in some embodiments, the control system tests, certifies and matches other users, such as one or more teacher users or learning users, with the user, and allows such users to interact with the user, in accordance with techniques set forth in this application, based on the user's selection of such a skill level. In the example pictured, selectable GUI sub-tools 309, when activated, allow the selection of such skill levels in increments, ranging from low to high skill, corresponding with the Common European Framework of Reference for Languages (“CEFR”) scale, and include: an individually selectable A1 spoken language level sub-tool 311, in the form of an actuable GUI button which, when activated by the user, selects and indicates a language speaking skill level of a low-skilled beginner in the selected second language; an individually selectable A2 spoken language level sub-tool 313, in the form of an actuable GUI button which, when activated by the user, selects and indicates a language speaking skill level of a high-skilled beginner in the selected second language; an individually selectable B1 spoken language level sub-tool 315, in the form of an actuable GUI button which, when activated by the user, selects and indicates a language speaking skill level of a low-skilled intermediate learner of the selected second language; an individually selectable B2 spoken language level sub-tool 317, in the form of an actuable GUI button which, when activated by the user, selects and indicates a language speaking skill level of a high-skilled intermediate learner of the selected second language; an individually selectable A1 spoken language level sub-tool 319, in the form of an actuable GUI button which, when activated by the user, selects and indicates a language speaking skill level of a low-skilled advanced learner of the selected second language; an individually selectable A2 spoken language level sub-tool 321, in the form of an actuable GUI button which, when activated by the user, selects and indicates a language speaking skill level of a low-skilled advanced learner of the selected second language. In some embodiments, only one such GUI sub-tool and spoken skill level may be selected and, after selection, may prevent the selection of other such second languages (at least, until such time as the other sub-tool and its respective, indicated skill level is no longer selected, or deselected, in some embodiments).

FIG. 4 is a process flow diagram, illustrating several example steps 400 that may be carried out by a control system including computer hardware and software, such as the example control system set forth below, in reference to FIG. 13, included within a language learning system, in accordance with some additional embodiments.

Beginning with step 401, in some embodiments, the control system begins by first determining if all required software modules and networks for running the language learning system are available (e.g., on-line and active, with no reported functional errors, in some embodiments). If so, the control system proceeds to subsequent step 403, in which it presents a GUI to one or more users seeking to log in and access resources of the language learning system through a learning user account, to learn the same, particular second, goal learning language, as discussed above. In some such embodiments, such a GUI includes sub-tools for creating and/or logging in to such a learning user account on the control system. In some embodiments, such sub-tools require the entry of secure login credentials for a learning user (e.g., with a username, password and/or 2-factor authentication method) prior to providing account access, or other access to further, encrypted resources of the control system dedicated to such learning users, such as any of such additional resources discussed in this application.

In some embodiments, a user may be presented with options for selecting different types of user accounts, such as accounts for learning users or teaching users, with short- or long-term durations and/or resources. For example, some types of user accounts may require a one-time payment or free trial, for accessing a limited amount of learning resources (e.g., the user's account being limited to 3 A/V conversation learning sessions), while other types of advertiser user accounts may require a payment for less limited use of the system, over a longer specified, or unspecified period of time (e.g., a one-year subscription), in various embodiments. In some embodiments, if such a user selects or is otherwise identified as a teaching user, rather than a learning user, of the language learning system, the control system may proceed to step 429 et seq., in which it performs similar authentication and log-in steps as set forth above provided separately for teaching users. In any event, in some embodiments, the control system requires the user to accept legally binding terms and conditions (e.g., via electronic signature) for creating, configuring and using that type of account for purposes set forth in this application, before permitting the user to proceed to subsequent steps, in some such embodiments.

However, assuming that a learning user has successfully logged in to a learning user account, in step 403, and accepted such terms and conditions, in some embodiments, the control system then proceeds to step 405, in which the control system begins to present a series of GUIs to the learning user with GUI tools facilitating practical learning of human languages, in part, by remote teleconferencing, in accordance with any and/or all embodiments set forth in the present application for language learning platforms. In some embodiments, however, if, at steps 401 or 429, the user did not successfully log in to such an account, or accept the terms and conditions, the user may be denied access to any of those GUI tools (e.g., with different GUI aspects informing the user that no account has been set up and that the user has been barred from access to those GUI tools), and the control system returns to the starting position. Assuming, however, at step 403, that the user has accepted the terms and conditions, and the control system has proceeded to step 405, as discussed above, the control system may proceed by requesting that the learning user select a first (“main” or “native”) human language, in which the learning user has native or another high level of fluency at the outset (i.e., prior to using the control system). For example, as discussed above, in some embodiments, the learning user may use language selection GUI sub-tool 135, for selecting such a first, main human language. Also in step 405, or in some embodiments, in an immediately subsequent step, the control system assesses that native or other level of fluency of the user (e.g., by testing or requesting an indication and/or certification of that level of high proficiency in that first, main human language, in various embodiments).

Next, the control system may proceed to step 407, in which it requests that the learning user select a second, goal learning language, as discussed in this application, e.g., using second, goal learning language selection tool 205, as discussed above. Whereas, in some embodiments, the first, main human language selected by the learning user is a user's native human language, or another human language in which the learning user has fluency, in some embodiments, the second language is a different human language, which the user desires to learn and/or practice, and may not have fluency in, in some embodiments. For example, in some embodiments, the learning user may desire and/or be required to learn and increase their fluency in the second, goal learning language for any number of various reasons, including business, employment, academic, travel, personal, and/or other reasons. Also in step 407, or in some embodiments, in an immediately subsequent step, the control system assesses the level of fluency and/or speaking ability of the user in that second, goal learning language (e.g., by testing or requesting an indication and/or certification of that level of proficiency in that second human language, in various embodiments).

Next, the control system may next proceed to step 409, in which it requests that the learning user select a Learning Path. As discussed elsewhere in this application, in some embodiments, the learning user may desire and/or be required to learn and increase their fluency in the second, goal learning language for any number of various reasons, including business, employment, academic, travel, personal, and/or other reasons. And, in some such embodiments, the learning user may select and activate one or more “Learning Paths,” based on and corresponding with those objectives, within the meaning of this application. In some embodiments, such a Learning Path includes a set of software and/or hardware modules maintained by the control system which, when activated, present GUIs of one or more types for carrying out specialized learning activities addressing the specific needs of each selected Learning Path. In some embodiments, upon the learning user selecting such a Learning Path, the control system creates groups or particular cohorts of users based on their sharing one or more Learning Path(s) (having each selected it at step 409), and then assigns common or group activities, GUIs and/or chat rooms for A/V conversations, as will be discussed below.

Similarly, and returning for the time being to step 429, if a user does not log in to the control system as a learning user, and instead successfully logs in as a teaching user, in some embodiments, the control system proceeds to step 431, in which it, similarly to step 405, requests that the teaching user select a first (“main” or “native”) human language, in which the teaching user has native or another high level of fluency at the outset. For example, as discussed above, in some embodiments, the teaching user may use language selection GUI sub-tool 135, for selecting such a first, main human language. Also similarly, in step 431, or in some embodiments, in an immediately subsequent step, the control system assesses that native or other level of fluency of the teaching user (e.g., by testing or requesting an indication and/or certification of that level of high proficiency in that first, main human language, in various embodiments). However, distinctly from step 405, the teaching user is requested to indicate that this first, native language is a “goal teaching” language, in some embodiments, meaning that the teaching user has an interest in teaching language skills (e.g., leading, assessing, correcting and otherwise guiding the learning of speaking skills of other, learning users) in that first, native language (e.g., using a GUI tool for indicating that such a first, native language is such a goal teaching language for the teaching user). In some embodiments, the control system may verify the native or other high level of fluency that the teaching user so indicates, in subsequent step 433. For example, in some embodiments, in step 433, the control system may conduct a verbal and/or oral proficiency test of the teaching user, and grade the teaching user's performance on such a test. In some embodiments, if, and only if, the teaching user's score or other assessment on such a test (e.g., via an AI submodule) determines a level of fluency of the teaching user exceeding a particular pre-set threshold, the control system completes the assignment of the language so selected by the teaching user as a first, native, goal teaching language for the teaching user. In some embodiments, in subsequent step 435, the control system also requests that the teaching user indicate and assign one or more other language(s), which the teaching user will not be teaching, but in which the teaching user has some ability to converse (e.g., a sufficient ability to communicate instructions to learning users in carrying out A/V conversations, as discussed in this application). Also, and similarly to step 409 with respect to learning users, in step 437, a teaching user may be asked to select one or more Learning Path(s), corresponding with their interest(s) and/or experience(s) in using either or both their first, goal teaching language and/or their second language.

The control system may next proceed, either from step 409 or step 437, to step 411, in which it creates and schedules a first, “Group Immersion” A/V conversation session, held in a first, Group Immersion A/V chat room, at a pre-planned time and for a pre-planned duration (e.g., by a user using scheduling GUI tool 130, as discussed above). In some embodiments, a relatively large number of users, including both learning users and teaching users, may be assigned to such a Group Immersion A/V conversation session and corresponding chat room. For example, in some embodiments, between 10 and 50 such users are assigned to such a single Group Immersion A/V conversation session and corresponding chat room, at the same Universal Time (e.g., with invitations and chat room links corresponding to the local time zone selected by each user, matching that Universal Time for each user). As another example, in some embodiments, between, or between about 20 and 40 users are so assigned to such a single Group Immersion A/V conversation session and corresponding chat room. As another example, in some embodiments, 30, or about 30, users are so assigned to such a single Group Immersion A/V conversation session and corresponding chat room. In some embodiments, in advance of the time for such a Group Immersion A/V conversation session, each user within such a cohort is sent an actuable link to such a chat room and, by “clicking on” that link, is next presented with a GUI for engaging in that Group Immersion A/V conversation session (e.g., with the aid of a microphone and/or, in some embodiments, a camera, of each respective user's personal computer, each sharing a communications network with the control system).

In any event, upon entering such a Group Immersion A/V chat room and conversation session, each user of such a cohort may be presented with an introductory media and/or message GUI created by the control system (e.g., prior to entry into the chat room and being permitted to converse with other users, in some embodiments) in step 413. In some embodiments, such an introductory message is provided that includes instructions to each user concerning the speaking tasks assigned to them, and goals for each user (e.g., in terms of speaking time and/or as a percentage of total speaking time of all users). The control system may also allow the users to engage in a group discussion, such as an introductory conversation, with other users within the Group Immersion A/V chat room and conversation session, in step 415, in some embodiments. Based on the results of those introductory conversations, in some embodiments, the control system proceeds to steps 417 and 419, in parallel, in which it applies a learning user assessment module and a teaching user assessment module (included within, or connected for communications with, the control system), to the speaking performance of any such learning user and any such teaching user, respectively. In some embodiments, either such an assessment module may, at least in part, include an artificial intelligence (e.g., machine learning) sub-module, which compares a variety of factors of each such user, based on performances of prior learning and teaching users, and their abilities as rated previously, over time (e.g., by administrators coaching the machine learning sub-module with examples of such high- and low-ability prior users). In some embodiments, either such an assessment module may, at least in part, include a speaking time recording sub-module, in which each user's amount of time speaking, proportion of time speaking relative to other speakers, and/or verbal fluidity and talking speed (in various embodiments), may be determined. For example, in some embodiments, such a sub-module first transcribes each user's speech during the A/V session into a OCRed transcript, which is then analyzed for grammatical and/or pronunciation errors, speech rate, and such speaking time, and proportion of speaking time, in some embodiments. In some embodiments, in subsequent step 421, users may then be compared and associated with each other to different degrees, e.g., by a user matching module of the control system. In some embodiments, such an algorithm creates a comparative coefficient of speaking ability in a human language (e.g., by regression analysis of a group of weighted comparisons of a group of statistical indicators, such as any of the statistical indicators of speaking performance set forth in this application) applied to each learning user and teaching user. In some such embodiments, such users will later be grouped together, in tranches or cohorts of user, based on having a similar or otherwise related (e.g., opposing abilities) such coefficient of speaking ability, as will be discussed in greater detail below, in some embodiments. However, in some such embodiments, teaching users may be matched with learning users in such a tranche or cohort only if their assessed and determined language skill level (e.g., by their coefficient of speaking ability) is higher than all learning users in that tranche or cohort. In some such embodiment, in step 423, if a teaching user does not have such a higher assessed and determined language skill level than all users in at least one such tranche or cohort, the teaching user is eliminated from, or not so assigned to, all such tranches or cohorts, and re-enters the Group Immersion A/V chat room, where they may attempt to be matched with others again by the control system in such a tranche or cohort, in a subsequent Group Immersion A/V conversation session.

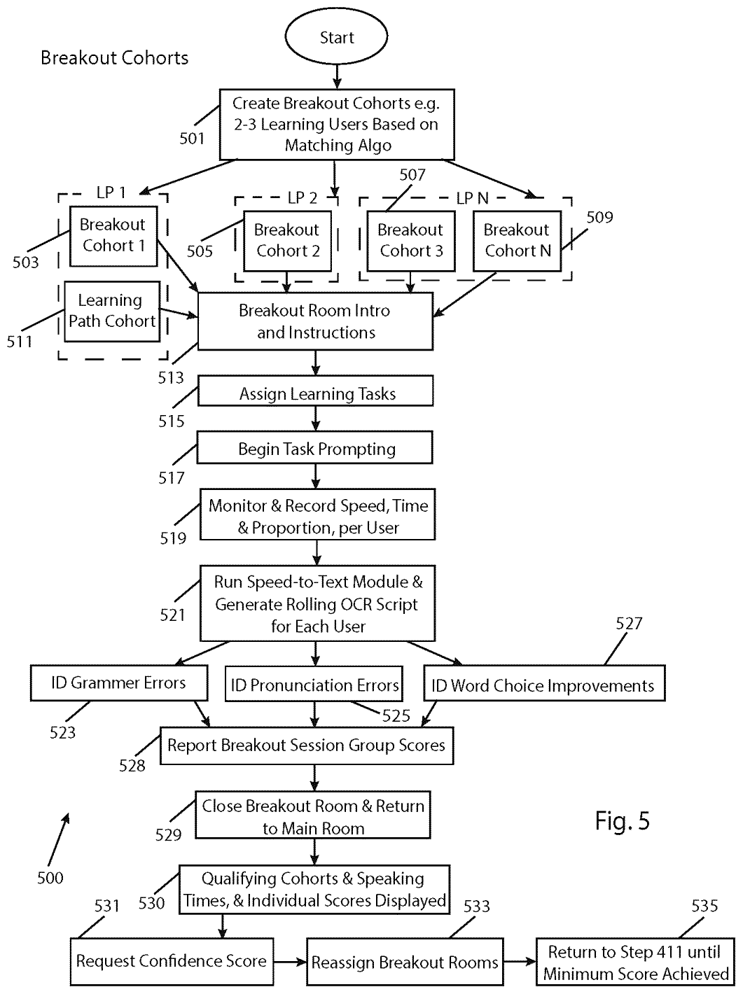

However, in some embodiments, the control system next proceeds, in step 425, to create additional A/V chatrooms, each for a single tranche or cohort of fewer users (e.g., 3 to 4 users each), known as “Breakout Rooms.” The remaining teaching users and learning users that are assigned to such a tranche or cohort are then assigned to one such breakout room, and the control system proceeds to the process set forth below, in reference to FIG. 5, in some embodiments.

It should be understood that the above steps, and number and order of steps, is exemplary only of certain embodiments set forth in this application, and are not intended to limit the application in any way. In fact, virtually unlimited alternative orders, numbers, instances of the above steps, in addition with countless additional and alternative steps may be performed, within the scope of the present application and inventions herein, as will be readily apparent to those of skill in the art.

FIG. 5 is a process flow diagram, illustrating several additional example steps 500 that may be carried out by a control system including computer hardware and software, such as the example control system set forth below, in reference to FIG. 13, of a language learning system, in accordance with some additional embodiments.

As discussed above, in reference to FIG. 4, in some embodiments, users may be grouped together, in separate tranches or cohorts of users, based on having similar results of control system assessments and determinations, in steps 417, 419 and 421. In some embodiments, the control system creates a set of tranches or cohorts of users (“Breakout Cohorts”) for the purpose of holding additional A/V conversation sessions (“Breakout Sessions”) in separate, additional A/V chat rooms hosted by the control system (“Breakout Rooms”), in step 501. As mentioned above, in some embodiments, each such cohort of users consists of significantly fewer users (e.g., about 3 to 4 users) than the cohort of users present in the first, Group Immersion A/V chat room (e.g., having about 30 users). Also as discussed above, in some embodiments, each Breakout Cohort may be created to include a group of such fewer users having a similar speaking ability in a particular second, goal learning language. In some embodiments, the control system assigns each user exclusively to one such Breakout Cohort. For example, in step 503, a first set of about 3 such users is assigned exclusively to a first Breakout Cohort; in step 505, a second set of another about 3 such users is assigned exclusively to a second Breakout Cohort; in step 507, a third set of another about 3 such users is assigned exclusively to a third Breakout Cohort; and so on, as the control system continues creating such a series of discrete sets of users, each being assigned to separate Breakout Cohorts, until, in step 509, a final, or “Nth,” set of another about 3 such users is assigned exclusively to an “Nth” Breakout Cohort. In some embodiments, users are assigned to such Breakout Cohorts, at least in part, based on each user having selected the same Learning Path, as discussed in this application. For example, as pictured: users assigned to the first Breakout Cohort, in step 503, share a first Learning Path (denoted “LP1”); whereas, users assigned to the second Breakout Cohort, in step 505, share a second Learning Path (denoted “LP2”); whereas, users assigned to the third and Nth Breakout Cohorts, in steps 507 and 509, all share another Learning Path (denoted “LPN”); and so forth. In some embodiments, some users may be assigned (exclusively or non-exclusively, despite the general rule that users should otherwise be assigned to only one Breakout Cohort) to special Breakout Cohorts, based only on the users having selected one or more (or, in some embodiments, all) of the same Learning Path(s), in step 511.

Next, in step 513, In some embodiments, such Breakout Cohorts are assigned to separate Breakout Rooms (which, as discussed above, are additional, separate A/V chat rooms for hosting an A/V conversation session). In some embodiments, also in step 513, additional introductory message GUIs (one per each such Breakout Room) are created and provided by the control system (e.g., prior to entry into a chat room/Breakout Room, and/or prior to being permitted to converse with other users, in some embodiments). In some embodiments, such an introductory message includes instructions to each user of the Breakout Cohort concerning the speaking tasks assigned to them, and goals for each user (e.g., in terms of speaking time and/or a percentage of total speaking time of all users that the user should attempt to speak). The control system may also allow the users to engage in a group discussion, such as an introductory conversation, with other users within the Breakout Room, in some embodiments. However, in some embodiments, the control system may create and/or select particular learning tasks to be carried out by the learning users and teaching user(s) within the Breakout Room, in step 515. For example, in some embodiments, one or more users are instructed to begin and/or lead oral discussion of a subject matter topic, introduced by the control system via a GUI. For example, in some such embodiments, such a subject matter topic is introduced by a GUI tool of the control system displaying a title, description and/or other media signifying the subject matter to be discussed, and assigning it to one or more user(s) to begin and/or lead a discussion regarding that subject matter topic. In some embodiments, such a subject matter topic is selected based on the topic being related to a Learning Path selected by one or more users (and/or, in some embodiments, a Learning Path selected by all of the one or more users). In some embodiments, in subsequent step 517, the control system may assign more specific learning tasks and conversational challenges to one or more (or, in some embodiments, each) of the user(s). For example, in some embodiments, the control system may present one or more GUI tools instructing one or more users to complete a speaking task involving the answering of a question spoken (e.g., by a teaching user, recording or by synthesized speech by the control system). As such users begin and lead such discussions, respond to such discussions, and/or complete such speaking tasks, in step 519, in some embodiments, the control system monitors and/or records and applies a user assessment module to the speaking performance of each user. In some embodiments, such a speaking performance assessment module may, at least in part, include an artificial intelligence (e.g., machine learning) sub-module, which compares a variety of factors of each such user, such as their patterns of speech. In some embodiments, such a comparison is based on indicators of performances of prior users of similar assessed speaking abilities in the goal learning language, and changes in those abilities as rated previously, over time (e.g., by administrators coaching the machine learning sub-module with examples of such high- and low-ability prior users). In some embodiments, such an assessment module may, at least in part, include a speaking time recording sub-module, in which each user's amount of time speaking in the Breakout Room, proportion of time speaking in the Breakout Room relative to other speakers speaking in the Breakout Room, and the user's verbal fluidity and talking speed, may be determined. For example, in some embodiments, in step 521, such a sub-module first transcribes each user's speech during the A/V session into a separate, Optical Character Recognition enabled (“OCRed”) transcript. In some such embodiments, in step 523, each user's speech during the A/V conversation session (e.g., the transcript thereof, including time signatures for each word spoken) is then analyzed for grammatical errors, which may be identified and indicated to the user and or a teaching user by specialized GUI tools, and a grammatical error recognition sub-module of the control system, in some embodiments. Also, in parallel, simultaneous step 525, in some embodiments, a pronunciation error recognition sub-module of the control system may review and analyze recordings of each user's speech from the A/V conversation session, and identify and indicate errors in pronunciation by each user, in additional GUI tools. Also, in another parallel, simultaneous step 527, in some embodiments, a syntax and/or word choice assessment sub-module of the control system may review and analyze recordings of each user's speech from the A/V conversation session, and identify and indicate errors or sub-optimal word choice of each user, in additional GUI tools. However, in some embodiments, such indications, as set forth in steps 523, 525 and 527 are not reported until after the Breakout Session has ended (e.g., in some embodiments, after the user has returned to the first, Group Immersion A/V chat room), as will be discussed further below.

In some embodiments, in step 528, a Breakout Cohort performance score is calculated by the assessment sub-module for each Breakout Cohort, and reported to each user of the respective Cohort via GUI tools, at the end of its Breakout Session. For example, in some embodiments, each user's speaking time is reported via such GUI tools (e.g., as a percentage of total speaking time), as discussed above. As another example, in some embodiments, the assessment module reports whether each user's speaking time meets or exceeds a threshold for successfully completing the Breakout Session. In some embodiments, the assessment module determines whether all users within a Breakout Cohort to have met or exceeded such a threshold, and, if not, the assessment module determines that the Breakout Cohort has not successfully completed the Breakout Session. And, in some such embodiments, the assessment module reports whether the Breakout Cohort, as a whole, has successfully completed the Breakout Session, as at least part of a Breakout Cohort performance score report. In some embodiments, the assessment sub-module may report a total number of instances of any of the errors discussed above, and/or a total number of instances of correct performance of speaking tasks, as at least part of a Breakout Cohort performance score report through GUI tools, to the user(s), in step 528.

After the Breakout Session has concluded (e.g., after a preset duration of time has elapsed after the start time designated for the session), the control system may proceed to step 529, in some embodiments, in which it ends each of the Breakout Rooms, and returns all users to the larger first, Group Immersion A/V chat room, as discussed in FIG. 4, above.

In some embodiments, in subsequent step 530, the assessment module ranks and reports each Breakout Cohort's Breakout Cohort performance score report (e.g., on a leader board GUI tool). For example, in some embodiments, the assessment module reports whether each Breakout Cohort has successfully completed their respective Breakout Session (e.g., each user of such a cohort having spoken for a time or proportion of the Breakout Session's total time meeting or exceeding a pre-set minimum threshold for such speaking times.) In some embodiments, for each user of each Breakout Cohort, the assessment sub-module reports a total number of instances of any or all of the errors discussed above (determined in steps 523, 525 and 527) and/or a total number of instances of correct performance of speaking tasks, as a Breakout Session results report through GUI tools, to the user(s).

Also upon so returning each user of each Breakout Cohort to the first, Group Immersion A/V chat room (“Main Room”), in step 531, in some embodiments, the control system requests each learning user to report a Confidence Score, meaning a numerical or other rating (e.g., on a scale of 1-4) of their confidence that they have spoken well, and/or improved their spoken language skills, in their second, goal, learning language. Also upon so returning each user to the first, Group Immersion A/V chat room (“Main Room”), in some embodiments, the control system may report any or all of the ratings, scores, speaking times, relative speaking times, for each user in a Score Reporting GUIs, in some embodiments, in step 533. In some embodiments, in step 535, each user must meet or exceed one or more thresholds for particular score(s) relating to their speech (e.g., a minimum speaking time, or proportion of speaking time, as discussed above), or they are then returned to steps 411 et seq., as set forth above, and repeat all such steps until they have so met or exceeded such threshold(s).

It should be understood that the above steps, and number and order of steps, is exemplary only of certain embodiments set forth in this application, and are not intended to limit the application in any way. In fact, virtually unlimited alternative orders, numbers, instances of the above steps, in addition with countless additional and alternative steps may be performed, within the scope of the present application and inventions herein, as will be readily apparent to those of skill in the art.

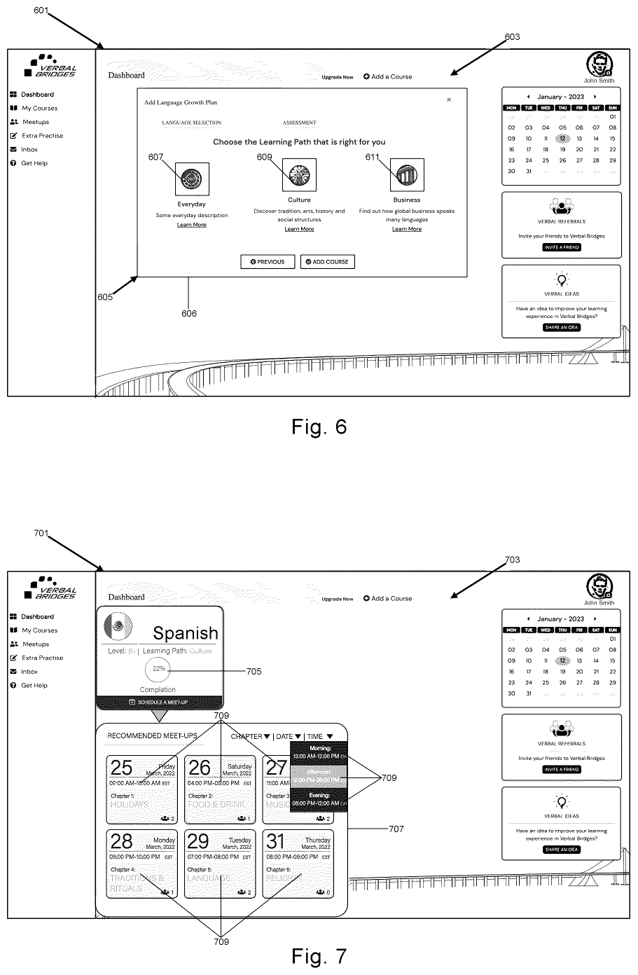

FIG. 6 depicts an example GUI 601, including some additional example GUI tools 603, which also may be utilized by a user of such learning system, in accordance with some embodiments. As with other GUIs and GUI tools set forth in the present application, in some embodiments, GUI tools 603 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with other figures including GUIs, above, a computer, such as example computer has been omitted in the present figure.

In some embodiments, GUI 601 and GUI tools 603 include several of the same GUI tools set forth above, with reference to FIGS. 1-3. However, after the user completed indicating their speaking skill level in the second language, using GUI sub-tools 309, as discussed in FIG. 3, above, and after the learning system has recorded that skill level as a setting, and a part of the profile of the user, additional example GUI tools, included in GUI tools 603, have been created by the system. For example, an example second language Learning Path selection tool 605 is provided by the learning system, in the form of a pop-up window 606, allowing a user to select a Learning Path, as set forth in this application. As explained in greater detail elsewhere in this application, the Learning System may provide GUI tools, form Breakout Cohorts, hold Breakout Sessions, take other particular actions, and provide other language learning tools tailored to a Learning Path of the user, as indicated by such a second language Learning Path selection tool 605, in some embodiments.

In some embodiments, learning users and teaching users, alike, may select a Learning Path(s), corresponding with their interest(s), need(s) and/or experience(s) in using goal learning languages, goal teaching languages and/or other languages, in various embodiments. For example, a user may wish to work on language skills for such a language due to business, employment, academic, travel, personal, and/or other reasons. And, in some such embodiments, a user may select and activate one or more Learning Paths based on and corresponding with those reasons, within the meaning of this application. In some embodiments, such a Learning Path includes a set of software and/or hardware modules maintained by the control system which, when activated, present GUIs of one or more types for carrying out specialized learning activities addressing the specific needs of each selected Learning Path. In some embodiments, upon the learning user selecting such a Learning Path, the control system creates groups or particular cohorts of users based on their sharing one or more Learning Path(s) (having each selected it at step 409), and then assigns common or group activities, GUIs and/or chat rooms for A/V conversations to such users, as discussed above.

In the example pictured, language Learning Path selection tool 605, when activated, allows the selection of one or more such Learning Paths, from an assortment of Learning Path indicator tools, such as the following examples: an individually selectable everyday activities and language Learning Path Indicator button 607, which, when activated by the user, selects everyday activities and common language needs for ordinary living as a language Learning Path for the user selecting it via GUI 601; an individually selectable cultural activities and language Learning Path Indicator button 609, which, when activated by the user, selects cultural exploration and travel as a language Learning Path for the user selecting it via GUI 601; and an individually selectable business and employment Learning Path Indicator button 611, which, when activated by the user, selects business and employment language needs as a language Learning Path for the user selecting it via GUI 601.

FIG. 7 depicts an example GUI 701, including some additional example GUI tools 703, which also may be utilized by a user of such learning system, in accordance with some embodiments. As with other GUIs and GUI tools set forth in the present application, in some embodiments, GUI tools 703 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with other figures including GUIs, above, a computer, such as example computer has been omitted in the present figure.

In some embodiments, GUI 701 and GUI tools 703 include several of the same GUI tools set forth above, with reference to FIGS. 1-3 and 6. However, after the user completed selecting their Learning Path, as discussed above, and after the learning system has recorded that Learning Path as a setting, and a part of the profile of the user, additional example GUI tools, included in GUI tools 703, have been created by the system. For example, an example a Learning Path course progress indicator 705 is now provided by the learning system, showing a percentage of required course tasks for a Language Path to be complete (e.g., via a circular background element, and semi-circular effect covering the same percentage of the circular background element, as pictured), including successful A/V conversation Breakout Sessions and other learning tasks, have been completed by the user, in some embodiments.

In some embodiments, GUI tools 703 also include a scheduled A/V chat session recommendation tool 707. As mentioned above, in some embodiments, the learning system uses a matching algorithm to create one or more cohorts of users, and then schedules and creates A/V chat room to host an A/V chat session for each of those cohorts of users, in some embodiments. In some embodiments, where the learning system has already created a number of such cohorts and A/V chat rooms, and new user signs up, and selects a goal language, speaking ability and Learning Path, as discussed above, among other factors and personal characteristics, the learning system may match the new user to one or more such previously-created cohorts and A/V chat rooms and sessions. In some such embodiments, the learning system may then recommend and present selectable options for such a new user to join such cohort(s) and/or A/V chat rooms and sessions, using A/V chat session recommendation tool 707 (e.g., by clicking on any of a plurality of A/V chat session selection tools 709, each corresponding with such a A/V chat session scheduled on a plurality of future dates, as indicated).

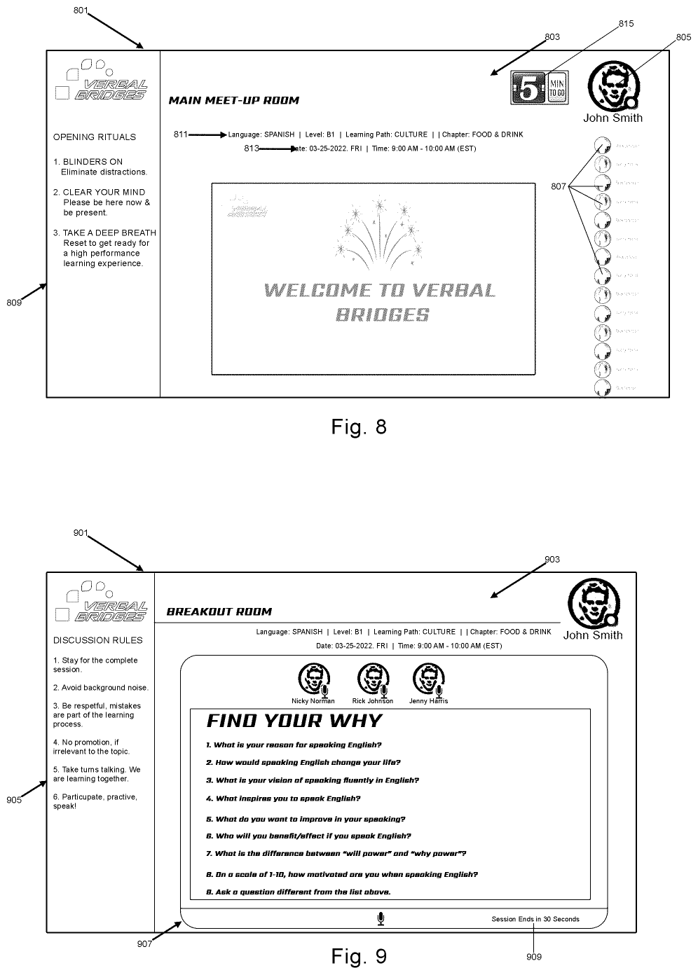

FIG. 8 depicts an example GUI 801, including some additional example GUI tools 803, which also may be utilized by a user of such learning system, in accordance with some embodiments. As with other GUIs and GUI tools set forth in the present application, in some embodiments, GUI tools 803 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with other figures including GUIs, above, a computer, such as example computer has been omitted in the present figure.

In some embodiments, GUI 801 and GUI tools 803 include several of the same GUI tools set forth above, with reference to FIGS. 1-3, 6 and 7. However, after the user completed scheduling an A/V conversation session, as suggested by the learning system in GUI 701 (or on an initial learning system initiative, or on the user's own initiative, in various alternative embodiments), as discussed above, additional example GUI tools related to a large, Group Immersion A/V chat room (e.g., hosting around 30 users) provided by the learning system, are provided.

As discussed elsewhere in this application, in some embodiments, the learning system provides such a large, Group Immersion A/V chat room to host an initial, group immersion A/V Conversation session between those users of that cohort. In some embodiments, where the example learning user (shown by avatar or representative picture 805) is present in such a Group Immersion A/V chat room, they may view similar avatars or representative pictures of all other users of the cohort of users grouped by the learning system and/or hosted in the Group Immersion A/V chat room. Examples of such avatars or representative pictures of all other users are shown, for example, as example other user avatars 807.

Also as mentioned above, in some embodiments, at the outset of such a group immersion A/V Conversation session, instructions, tasks or other guidance may be provided to all users within the cohort, as shown by example instructions GUI tool 809.

Information concerning the cohort of users, including their common Learning Path, and a current subtopic (a.k.a., “chapter”) may be provided in some embodiments, for example, as cohort characteristics indicators 811. In addition, in some embodiments, A/V Conversation session time and date indicators 813 may be provided. Finally, an A/V Conversation time-remaining indicator 815 may be provided, in some embodiments, aiding users in understanding the length of time they have remaining to complete speaking before the session expires.

It should be noted that, during such an A/V Conversation session, any and all users of the cohort may speak (e.g., in succession) and listen to one another (e.g., using microphones and speakers within the control system of their local computer), in some embodiments.

FIG. 9 depicts an example GUI 901, including some additional example GUI tools 903, which also may be utilized by a user of such learning system, in accordance with some embodiments. As with other GUIs and GUI tools set forth in the present application, in some embodiments, GUI tools 903 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with other figures including GUIs, above, a computer, such as example computer has been omitted in the present figure.

In some embodiments, GUI 901 and GUI tools 903 may include some of the same GUI tools set forth above, with reference to FIGS. 1-3, 6-8. However, after the user has participated in the large, Group Immersion A/V chat room, as discussed above, the learning system has moved the user into a Breakout Room, with a smaller Breakout Cohort of users (e.g., hosting 3 users, as pictured) derived from the cohort of users present in the large, Group Immersion A/V chat room, in some embodiments, as discussed above.

As mentioned above, in some embodiments, at the outset of such a Breakout Session, additional instructions may be provided to all users within the cohort, as shown by example instructions GUI tool 905. In addition, and also as discussed above, specific speaking tasks and/or other guidance for the Breakout Cohort may be provided, such as example conversational questions, provided in questioning GUI tool 907, which may, in some embodiments, be spoken out loud to all users in the Breakout Cohort by a text-to-speech submodule of the learning system. The users of the Breakout Cohort may be reminded of the time remaining for the Breakout Session, for example, by a remaining time indicator tool 909, and are instructed to make efforts to complete their speaking tasks (e.g., reaching or exceeding a threshold Speaking Time or proportion) within that allotted time, in some embodiments.

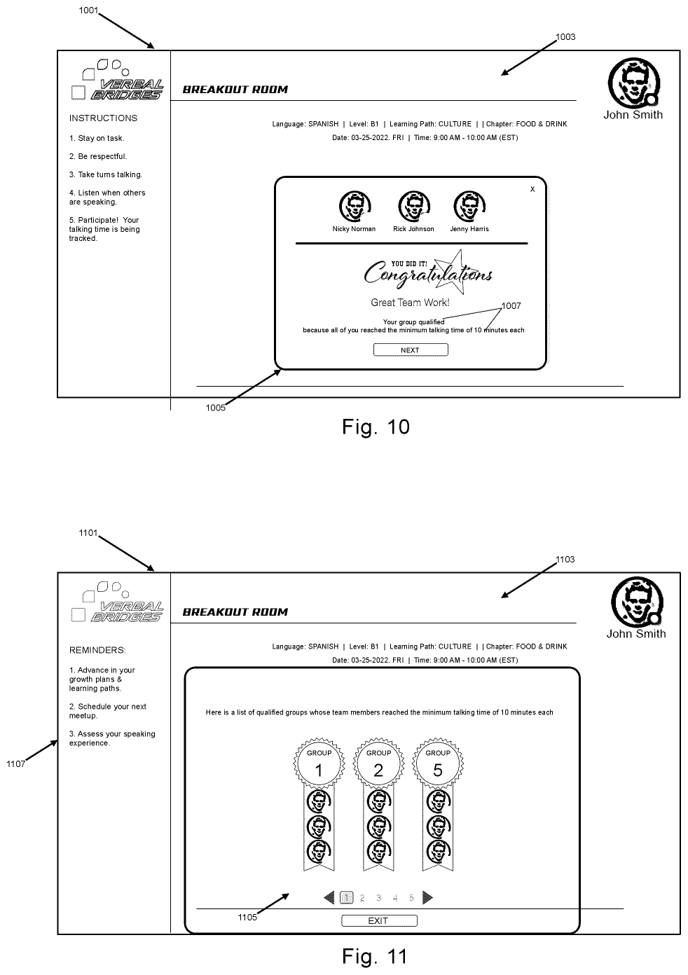

FIG. 10 depicts an example GUI 1001, including some additional example GUI tools 1003, which also may be utilized by a user of such learning system, in accordance with some embodiments. As with other GUIs and GUI tools set forth in the present application, in some embodiments, GUI tools 1003 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with other figures including GUIs, above, a computer, such as example computer has been omitted in the present figure.

In some embodiments, GUI 1001 and GUI tools 1003 may include some of the same GUI tools set forth above, with reference to FIGS. 1-3, 6-9. However, after completion of the Breakout Session, as discussed above, the learning system presents additional GUI tools, within GUI tools 1003, related to the results of the Breakout Session, and all users within the Breakout Cohort. More specifically, a Breakout Session results indicator tool 1005 is now provided. In some embodiments, Breakout Session results indicator tool 1005 includes explanatory sub-tools 1007, which may explain whether one, some or all users in the Breakout Cohort did or did not meet thresholds and/or objectives of the Breakout Session, completing tasks assigned to them, and whether the Breakout Session was successful, as discussed elsewhere in this application. For example, in the instance pictured, the Breakout Session is indicated to have been successful, with all users having completed the task of achieving a pre-planned threshold amount of time speaking during the Breakout Session.

FIG. 11 depicts an example GUI 1101, including some additional example GUI tools 1103, which also may be utilized by a user of such learning system, in accordance with some embodiments. As with other GUIs and GUI tools set forth in the present application, in some embodiments, GUI tools 1103 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with other figures including GUIs, above, a computer, such as example computer has been omitted in the present figure.

In some embodiments, GUI 1101 and GUI tools 1103 may include some of the same GUI tools set forth above, with reference to FIGS. 1-3, 6-10. However, after completion of the Breakout Session and being returned to the large, Group Immersion A/V chat room, in some embodiments, results of each Breakout Cohort (or, of Breakout Cohorts with successful results) are now shown in a Breakout Cohorts Results leader board 1105, in some embodiments.

In some embodiments, the learning system also provides parting reminders and instructions, in a reminders and instructions GUI tool 1107.

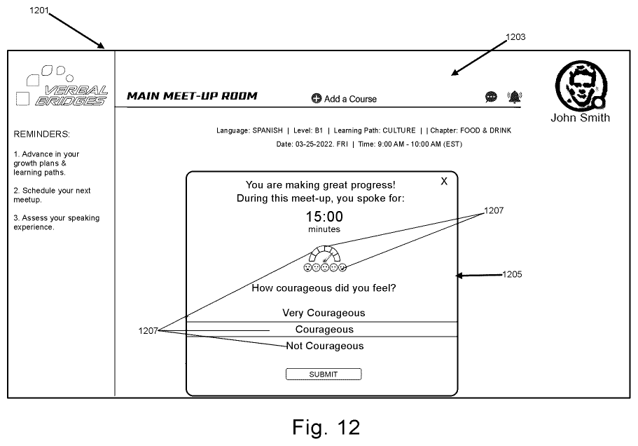

FIG. 12 depicts an example GUI 1201, including some additional example GUI tools 1203, which also may be utilized by a user of such a learning system, in accordance with some embodiments. As with other GUIs and GUI tools set forth in the present application, in some embodiments, GUI tools 1203 may be provided within, and controlled by, a control system including computer hardware and software, such as, but not limited to, the example control system set forth below, in reference to FIG. 13, in some such embodiments. In some embodiments, such a control system includes, or is included within, a computer, such as, an example computer 105, discussed above. For simplicity, however, as with other figures including GUIs, above, a computer, such as example computer has been omitted in the present figure.

In some embodiments, GUI 1201 and GUI tools 1203 may include some of the same GUI tools set forth above, with reference to FIGS. 1-3, 6-11. However, after results of each Breakout Cohort (or, of Breakout Cohorts with successful results) are shown, in some embodiments, each of the users (of each Breakout Cohort and/or each user in the larger cohort) are asked to record a Confidence Score, meaning a numerical or other rating of their confidence that they have spoken well, and/or improved their spoken language skills, in their second, goal, learning language. For example, in some embodiments, each user is provided with a Confidence Score eliciting GUI tool 1205 which, when actuated in particular regions, such as example actuable, indicative regions 1207, corresponding with a numerical or other rating, records that rating as the user's Confidence Score for that particular Breakout Session.

It should be understood, however, that the example Confidence Score eliciting GUI tool 1205 is only one example of the myriad possible Confidence Score eliciting GUI tools that fall within the scope of the inventions set forth in this application. For example, in alternative embodiments, a Confidence Score or other confidence assessment software module may be provided. In some such embodiments, the confidence assessment software module generates a Confidence Score by measurements different and/or additional data related to confidence, and records a Confidence Score based on an algorithm assessing confidence according to a weighting of such measurements. For example, in some embodiments, such measurements include a speaking hesitancy measurement, meaning an amount of time a user pauses during speaking. As another example, in some embodiments, such measurements include a speaking fluidity measurement, meaning an amount of incorrect or imprecise diction, in comparison to model recordings or data related to diction, for the same words spoken. As another example, in some embodiments, such measurements include at least one facial gesture recognition measurement, meaning a facial gesture recognition and confidence rating measurement. Of course, any other measurement known in the art may also be measured, and factored into such an algorithm, in various embodiments, as an alternative, or in addition to, any or all of the above-provided examples of such measurements, to generate a Confidence Score based, at least in part, on such measurements.

In any event, in some embodiments, the learning system may schedule and facilitate additional, specialized A/V interactions, to be held at a later time, based on such a Confidence Score. For example, in some embodiments, future breakout rooms including the user and other users having a similar Confidence Score, may be provided by the learning system. And, in some embodiments, the learning system grants or prevents different special access privileges to the user if the Confidence Score falls below, reaches and/or exceeds a preselected threshold for confidence set for the user (e.g., with the aid of Confidence Score threshold setting GUI tool) or otherwise assessed for the user (not pictured in the present figure).

FIG. 13 is a schematic block diagram of some elements of a control system (hereinafter, the “system” or “control system”) 1300, including computer hardware and software, in accordance with some example embodiments of the present invention. In some example embodiments, the control system incorporates a non-transitory machine-readable medium storing instructions that, when executed by one or more processors, execute various aspects of the present invention described herein. The generic and other components and aspects described herein are not exhaustive of the many different systems and variations, including a number of possible hardware aspects that might be used, in accordance with the example embodiments of the invention. Rather, the control system 1300 shown depicts some example embodiments.

Control system 1300 includes an input/output device 1301, a memory device 1303, long-term data storage device 1305, and processor(s) 1307. The processor(s) 1307 is (are) capable of receiving, interpreting, processing and manipulating signals and executing instructions for further processing and for output, pre-output and/or storage in and outside of the system. The processor(s) 1307 may be general or multipurpose, single- or multi-threaded, and may have a single core or several processor cores, including microprocessors. Among other things, the processor(s) 1307 is/are capable of processing signals and instructions for the input/output device 1301, to cause a user interface to be provided or modified for use by a user on hardware, such as, but not limited to, computer system peripheral devices, such as a mouse, keyboard, touchscreen and/or other display device 1319, providing specialized tools (e.g., providing a graphical user interface, a.k.a. a “GUI,” providing any of the GUI tools as set forth in this application providing input and output for, and for otherwise aiding a user in, the practical teaching and learning of human language(s), at least in part, through A/V conversation sessions and other A/V interactions, with the aid of A/V chat rooms. In some embodiments, such signals and instructions are based on display-controlling and input-facilitating software (e.g., on local machine(s) 1311, display device 1319 or smartphone 1320).

For example, user interface aspects, such as graphical “windows,” “buttons” and data entry fields, may present, via, for example, a display, any number of selectable options and/or data entry fields. When the option and/or data entry field is selected or data is entered by a user, such selection and/or data entry causes aspects of the control system to command other aspects of the control system to provide additional instructions, GUI tools or other techniques set forth in the present application related to aiding users in practicing, teaching and learning to speak human language(s), in some embodiments. In some embodiments, such selection and/or data entry causes aspects of the control system to provide access to particular GUI tools as set forth in this application for selecting and activating resources of a language Learning System, comprising or comprised in the control system, in some embodiments. For example, and as explained in greater detail elsewhere in this application, the control system may provide GUI tools tailored to a Learning Path of one or more users. In some embodiments, the control system may provide GUI tools for facilitating A/V conversations in chat rooms, as set forth herein. In some embodiments, the control system may calculate ratings and other assessments of performance of users of the system in speaking or teaching a goal learning language (e.g., by monitoring, calculating and comparing such results to pre-set thresholds for completing tasks successfully, and accessing additional resources through the control system as a result, such as additional learning resources and/or monetary rewards). The processor(s) 1307 may execute instructions stored in memory device 1303 and/or long-term data storage device 1305, and may communicate via system bus(ses) 1375. Input/output device 1301 is capable of input/output operations for the system, and may include and communicate through input and/or output hardware, and instances thereof, such as a computer mouse, scanning device or other sensors, actuator(s), communications antenna(ae), keyboard(s), smartphone(s) and/or PDA(s), networked or connected additional computer(s), camera(s) or microphone(s), a mixing board(s), reel-to-reel tape recorder(s), external hard disk recorder(s), additional movie and/or sound editing system(s) or gear, speaker(s), external filter(s), amp(s), preamp(s), equalizer(s), computer display screen(s) or touch screen(s). Such input/output hardware could implement a program or user interface created, in part, by software, permitting the system and user to carry out the user settings and input discussed in this application. Input/output device 1301, memory device 1303, data storage device 1305, and processor(s) 1307 are connected and able to send and receive communications, transmissions and instructions via system bus(ses) 1375. In some embodiments, data storage device 1305 is capable of providing mass storage for the system, and may be or incorporate a computer-readable medium, may be a connected mass storage device (e.g., flash drive or other drive connected to a Universal Serial Bus (USB) port or Wi-Fi), may use back-end (with or without middle-ware) or cloud storage over a network (e.g., the Internet) as either a memory backup for an internal mass storage device or as a primary memory storage means, or may simply be an internal mass storage device, such as a computer hard drive or optical drive. Generally speaking, the control system may be implemented as a client/server arrangement, where features of the system are performed on a remote server, networked to the client and made a client and server by software on both the client computer and server computer. In any event, the control system may include, or include network connections (e.g, wired, WAN, LAN, 5G, ethernet, satellite, and/or Internet connections) with, any of the example devices or auxiliary devices and/or systems, shown as Internet server(s) 1309, local machine(s) 1311, cameras and microphones 1313, sensor(s) 1314, internet of things or other ubiquitous computing devices 1315, Blockchain(s) 1317, mouse, keyboard, touchscreen and/or other display device 1319 and smartphone 1320. Similarly, the control system 1300 is capable of accepting input from any of those auxiliary devices and systems, and modifying stored data within them and within itself, based on any input or output sent through input/output device 1301.

Input and output devices may deliver their input and receive output by any known means, including, but not limited to, any of the hardware and/or software examples shown as Internet server(s) 1309, local machine(s) 1311, cameras and microphones 1313, sensor(s) 1314, Internet of things or other ubiquitous computing devices 1315, Blockchain(s) 1317, display device 1319 and smartphone 1320.

While the illustrated example of a control system 1300 in accordance with the present invention may be helpful to understand the implementation of aspects of the invention, any suitable form of computer system known in the art may be used—for example, in some embodiments, a simpler computer system containing just a processor for executing instructions from a memory or transmission source. The aspects or features set forth may be implemented with, and in any combination of, digital electronic circuitry, hardware, software, firmware, middleware or any other computing technology known in the art, any of which may be aided with external data from external hardware and software, optionally, by networked connection, such as by LAN, WAN, satellite communications networks, 5G or other cellular networks, and/or any of the many connections forming the Internet. The system can be embodied in a tangibly-stored computer program, as by a machine-readable medium and propagated signal, for execution by a programmable processor. The many possible method steps of the example embodiments presented herein may be performed by such a programmable processor, executing a program of instructions, operating on input and output, and generating output and stored data. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

What is claimed is:

1. A learning management system, comprising specialized computer hardware and software, comprising:
a first language selection tool, presented to a first user, configured to permit said first user to select a first human language, representing that said first user has fluency is said first human language;
a second language selection tool, presented to said first user, configured to permit said first user to select a second human language, representing that said first user seeks to develop skill in said second human language;
an A/V conversation software module, wherein said A/V conversation software module is configured to facilitate real-time learning of said second language by said first user through spoken conversations by enabling an A/V interaction between said first user and a second user, over a computer network; and
a speaking time tracking tool, configured to calculate:
a cumulative amount of time that said first user spends speaking during said A/V interaction;
a cumulative amount of time that said second user spends speaking during said A/V interaction;
a total time of said A/V interaction;
a ratio of the cumulative amount of time that said first user spends speaking during said A/V interaction to the total time of said A/V interaction; and
a ratio of the cumulative amount of time that said second user spends speaking during said A/V interaction to the total time of said A/V interaction; and
a GUI tool displaying a score of said first user, based, at least in part, on said ratio of the cumulative amount of time that said first user spends speaking during said A/V interaction to the total time of said A/V interaction.

2. The learning management system of claim 1, wherein said computer network comprises the Internet.

3. The learning management system of claim 1, wherein said computer hardware and software comprise a language ability testing and verification module, configured to test and verify said first user's skills with respect to said second language.

4. The learning management system of claim 3, wherein said language ability testing and verification module is configured to test and verify said second user's skills with respect to said second language.

5. The learning management system of claim 4, wherein said language ability testing and verification module is configured to test and verify said second user's skills with respect to said first language.

6. The learning management system of claim 3, wherein said system facilitates real-time learning of said second language by said first user through spoken conversations by enabling an A/V interaction between said first user and said second user only if said first user is verified, by said language ability testing and verification module, to have a skill level in said second language meeting a particular criterion.

7. The learning management system of claim 4, wherein said system facilitates real-time learning of said second language by said first user through spoken conversations by enabling an A/V interaction between said first user and said second user only if said second user is verified, by said language ability testing and verification module, to have a skill level in said second language reaching a particular threshold.

8. The learning management system of claim 5, wherein said system facilitates real-time learning of said second language by said first user through spoken conversations by enabling an A/V interaction between said first user and said second user only if said second user is verified, by said language ability testing and verification module, to have a skill level in said first language reaching a particular threshold.

9. The learning management system of claim 1, wherein said specialized computer hardware and software comprise a GUI tool displaying a score for said second user, based, at least in part on said proportion of the total time of said A/V interaction that said second user spends speaking during said A/V interaction.

10. The learning management system of claim 1, wherein said system issues an amount of redeemable credits based on said score for said first user.

11. The learning management system of claim 9, wherein said system issues an amount of redeemable credits based on said score for said second user.

12. The learning management system of claim 10, wherein said redeemable credits comprise a monetary credit.

13. The learning management system of claim 11, wherein said redeemable credits comprise a monetary credit.

14. The learning management system of claim 1, wherein the system comprises:
a confidence assessment software module configured to record a Confidence Score of said first user, based on at least one measurement taken by the system.

15. The learning management system of claim 1, wherein the system grants or prevents special access privileges to said first user if said first user's Confidence Score reaches and/or exceeds a preselected threshold for Confidence Scores set for, or otherwise applicable to them.

16. The learning management system of claim 15, wherein the system provides the first user with access to a second A/V interaction, if the first user's Confidence Score falls below the preselected threshold for Confidence Scores applicable to them.

17. The learning management system of claim 1, wherein the system grants or prevents special access privileges to said first user if said ratio of the cumulative amount of time that said first user spends speaking during said A/V interaction to the total time of said A/V interaction reaches and/or exceeds a preselected threshold for Confidence Scores applicable to them.

18. The learning management system of claim 1, wherein the system grants or prevents special access privileges to said first user if said ratio of the cumulative amount of time that said first user spends speaking during said A/V interaction to the total time of said A/V interaction meets or exceeds a preselected threshold for a ratio related to speaking time applicable to them.

19. The learning management system of claim 18, wherein the system provides the first user with access to a second A/V interaction, if said ratio of the cumulative amount of time that said first user spends speaking during said A/V interaction to the total time of said A/V interaction falls below the preselected threshold for speaking time applicable to them.
